(19) United States
(12) Patent Application Publication
(10) Pub. No.: US 2025/0119262 A1
(43) Pub. Date: Apr. 10, 2025

(54) TECHNIQUES FOR RESUMING SUSPENDED TRANSMIT SWITCHING

(71) Applicant: QUALCOMM Incorporated, San Diego, CA (US)

(72) Inventors: Yiqing CAO, Beijing (CN); Alberto RICO ALVARINO, San Diego, CA (US); Peter GAAL, San Diego, CA (US)

(21) Appl. No.: 18/836,190

(22) PCT Filed: Apr. 22, 2022
(86) PCT No.: PCT/CN2022/088366

§ 371 Date: Aug. 6, 2024

(51) Int. Cl. H04L 5/00

(52) U.S. Cl. CPC H04L 5/0078

(57) ABSTRACT

Various aspects of the present disclosure generally relate to wireless communication. In some aspects, a user equipment (UE) may transmit a first indication of one or more carriers, including a first carrier, that are affected by an operation associated with one or more other carriers. The UE may receive a second indication to switch a transmitting radio frequency (RF) chain of the UE from a second carrier to the first carrier at a first time. The UE may perform the operation at a second time that at least partially overlaps with the first time. The UE may suspend the switch of the transmitting RF chain to the first carrier based on performing the operation. The UE may configure the transmitting RF chain to be tuned to the first carrier or the second carrier at a third time that occurs after the second time. Numerous other aspects are described.

### FIELD OF THE DISCLOSURE

Aspects of the present disclosure generally relate to wireless communication and to techniques and apparatuses for resuming suspended transmit switching.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, to a network entity, a first indication of one or more carriers, including a first carrier, that are affected by an operation associated with one or more other carriers. The method may include receiving, from the network entity, a second indication to switch a transmitting radio frequency (RF) chain of the UE from a second carrier to the first carrier at a first time for a first uplink transmission. The method may include performing the operation associated with at least one of the second carrier or a third carrier at a second time that at least partially overlaps with the first time. The method may include suspending the switch of the transmitting RF chain to the first carrier based at least in part on performing the operation. The method may include configuring the transmitting RF chain to be tuned to the first carrier or the second carrier at a third time that occurs after the second time.

Some aspects described herein relate to a method of wireless communication performed by a network entity. The method may include receiving a first indication of one or more carriers, including a first carrier, associated with a UE that are affected by an operation associated with one or more other carriers. The method may include transmitting a second indication intended for the UE to switch a transmitting RF chain of the UE from a second carrier to the first carrier at a first time for a first uplink transmission. The method may include performing one or more actions based at least in part on an expected RF configuration of the UE after a suspension of the switch of the transmitting RF chain to the first carrier based at least in part on a performance of the operation by the UE.

Some aspects described herein relate to a UE for wireless communication. The UE may include a memory and one or more processors coupled to the memory. The one or more processors may be configured to transmit, to a network entity, a first indication of one or more carriers, including a first carrier, that are affected by an operation associated with one or more other carriers. The one or more processors may be configured to receive, from the network entity, a second indication to switch a transmitting RF chain of the UE from a second carrier to the first carrier at a first time for a first uplink transmission. The one or more processors may be configured to perform the operation associated with at least one of the second carrier or a third carrier at a second time that at least partially overlaps with the first time. The one or more processors may be configured to suspend the switch of the transmitting RF chain to the first carrier based at least in part on performing the operation. The one or more processors may be configured to configure the transmitting RF chain to be tuned to the first carrier or the second carrier at a third time that occurs after the second time.

Some aspects described herein relate to a network entity for wireless communication. The network entity may include a memory and one or more processors coupled to the memory. The one or more processors may be configured to receive a first indication of one or more carriers, including a first carrier, associated with a UE that are affected by an operation associated with one or more other carriers. The one or more processors may be configured to transmit a second indication intended for the UE to switch a transmitting RF chain of the UE from a second carrier to the first carrier at a first time for a first uplink transmission. The one or more processors may be configured to perform one or more actions based at least in part on an expected RF configuration of the UE after a suspension of the switch of the transmitting RF chain to the first carrier based at least in part on a performance of the operation by the UE.

Some aspects described herein relate to a non-transitory computer-readable medium that stores a set of instructions for wireless communication by a UE. The set of instructions, when executed by one or more processors of the UE, may cause the UE to transmit, to a network entity, a first indication of one or more carriers, including a first carrier, that are affected by an operation associated with one or more other carriers. The set of instructions, when executed by one or more processors of the UE, may cause the UE to receive, from the network entity, a second indication to switch a transmitting RF chain of the UE from a second carrier to the first carrier at a first time for a first uplink transmission. The set of instructions, when executed by one or more processors of the UE, may cause the UE to perform the operation associated with at least one of the second carrier or a third carrier at a second time that at least partially overlaps with the first time. The set of instructions, when executed by one or more processors of the UE, may cause the UE to suspend the switch of the transmitting RF chain to the first carrier based at least in part on performing the operation. The set of instructions, when executed by one or more processors of the UE, may cause the UE to configure the transmitting RF chain to be tuned to the first carrier or the second carrier at a third time that occurs after the second time.

Some aspects described herein relate to a non-transitory computer-readable medium that stores a set of instructions for wireless communication by a network entity. The set of instructions, when executed by one or more processors of the network entity, may cause the network entity to receive a first indication of one or more carriers, including a first carrier, associated with a UE that are affected by an operation associated with one or more other carriers. The set of instructions, when executed by one or more processors of the network entity, may cause the network entity to transmit a second indication intended for the UE to switch a transmitting RF chain of the UE from a second carrier to the first carrier at a first time for a first uplink transmission. The set of instructions, when executed by one or more processors of the network entity, may cause the network entity to perform one or more actions based at least in part on an expected RF configuration of the UE after a suspension of the switch of the transmitting RF chain to the first carrier based at least in part on a performance of the operation by the UE.

Some aspects described herein relate to an apparatus for wireless communication. The apparatus may include means for transmitting, to a network entity, a first indication of one or more carriers, including a first carrier, that are affected by an operation associated with one or more other carriers. The apparatus may include means for receiving, from the network entity, a second indication to switch a transmitting RF chain of the apparatus from a second carrier to the first carrier at a first time for a first uplink transmission. The apparatus may include means for performing the operation associated with at least one of the second carrier or a third carrier at a second time that at least partially overlaps with the first time. The apparatus may include means for suspending the switch of the transmitting RF chain to the first carrier based at least in part on performing the operation. The apparatus may include means for configuring the transmitting RF chain to be tuned to the first carrier or the second carrier at a third time that occurs after the second time.

Some aspects described herein relate to an apparatus for wireless communication. The apparatus may include means for receiving a first indication of one or more carriers, including a first carrier, associated with a UE that are affected by an operation associated with one or more other carriers. The apparatus may include means for transmitting a second indication intended for the UE to switch a transmitting RF chain of the UE from a second carrier to the first carrier at a first time for a first uplink transmission. The apparatus may include means for performing one or more actions based at least in part on an expected RF configuration of the UE after a suspension of the switch of the transmitting RF chain to the first carrier based at least in part on a performance of the operation by the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a transmit (Tx) chain and a receive (Rx) chain of a UE, in accordance with the present disclosure.

FIG. 5 is diagram illustrating an example of carrier switching.

FIGS. 6-8 are diagrams of examples associated with resuming suspended transmit switching, in accordance with the present disclosure.

FIG. 9 is a diagram illustrating an example process performed, for example, by a UE, in accordance with the present disclosure.

FIG. 10 is a diagram illustrating an example process performed, for example, by a network entity, in accordance with the present disclosure.

FIG. 11 is a diagram of an example apparatus for wireless communication.

FIG. 12 is a diagram of an example apparatus for wireless communication.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

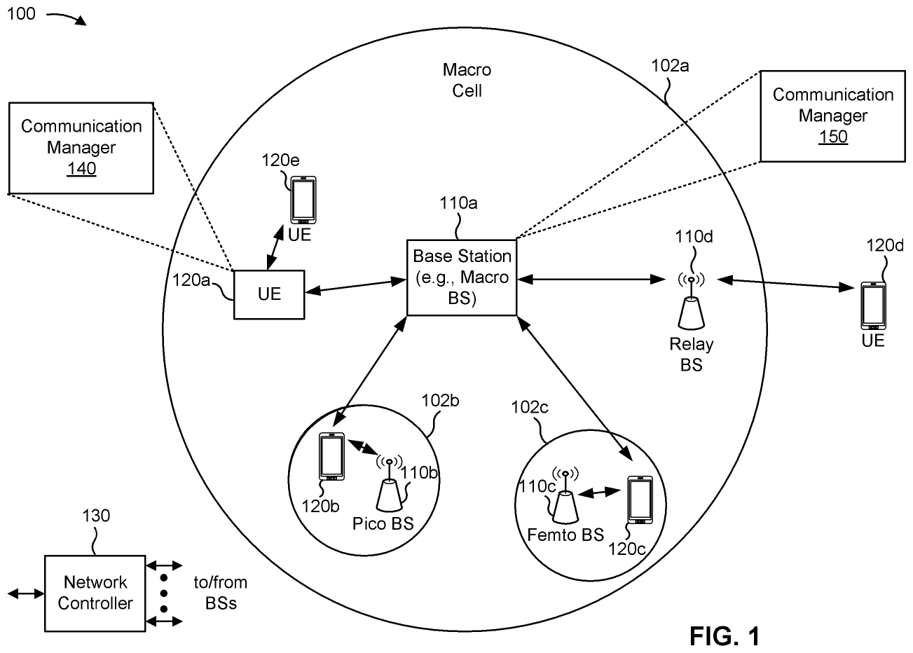

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (for example, the base station 110) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network entity, a first indication of one or more carriers, including a first carrier, that are affected by an operation associated with one or more other carriers; receive, from the network entity, a second indication to switch a transmitting radio frequency (RF) chain of the UE from a second carrier to the first carrier at a first time for a first uplink transmission; perform the operation associated with at least one of the second carrier or a third carrier at a second time that at least partially overlaps with the first time; suspend the switch of the transmitting RF chain to the first carrier based at least in part on performing the operation; and configure the transmitting RF chain to be tuned to the first carrier or the second carrier at a third time that occurs after the second time. Additionally, or alternatively, the communication manager 140 may perform one or more other operations described herein.

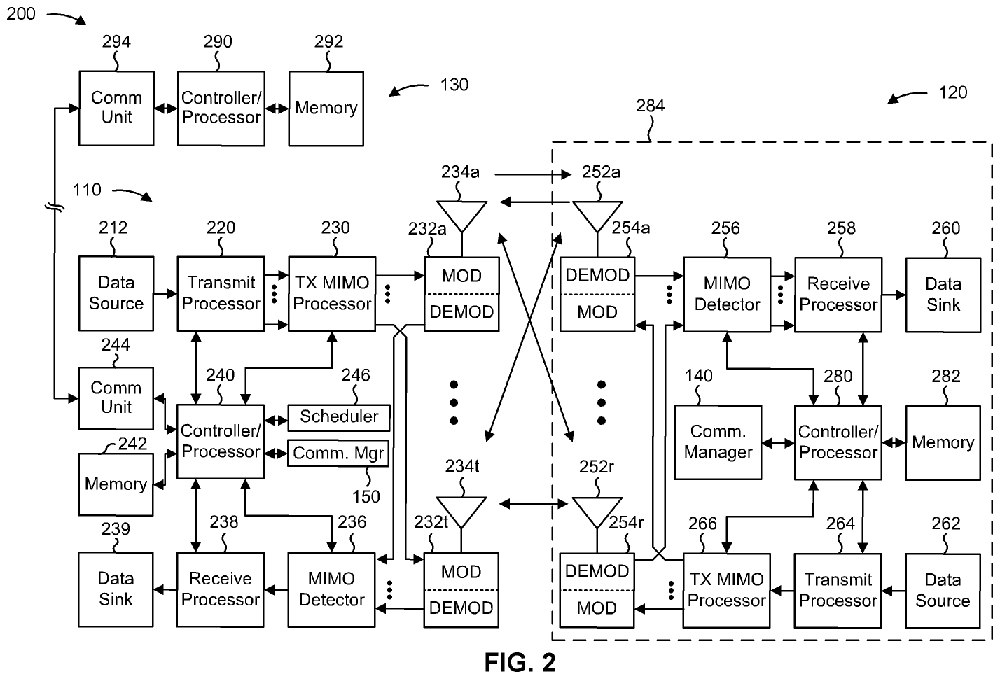

In some aspects, a network entity (shown in FIGS. 1 and 2 as a base station 110 as an example) may include a communication manager 150. As described in more detail elsewhere herein, the communication manager 150 may receive a first indication of one or more carriers, including a first carrier, associated with a UE that are affected by an operation associated with one or more other carriers; transmit a second indication, intended for the UE, to switch a transmitting RF chain of the UE from a second carrier to the first carrier at a first time for a first uplink transmission; and perform one or more actions based at least in part on an expected RF configuration of the UE after a suspension of the switch of the transmitting RF chain to the first carrier based at least in part on a performance of the operation by the UE. Additionally, or alternatively, the communication manager 150 may perform one or more other operations described herein.

As indicated above, FIG. 1 is provided as an example. Other examples may differ from what is described with regard to FIG. 1.

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

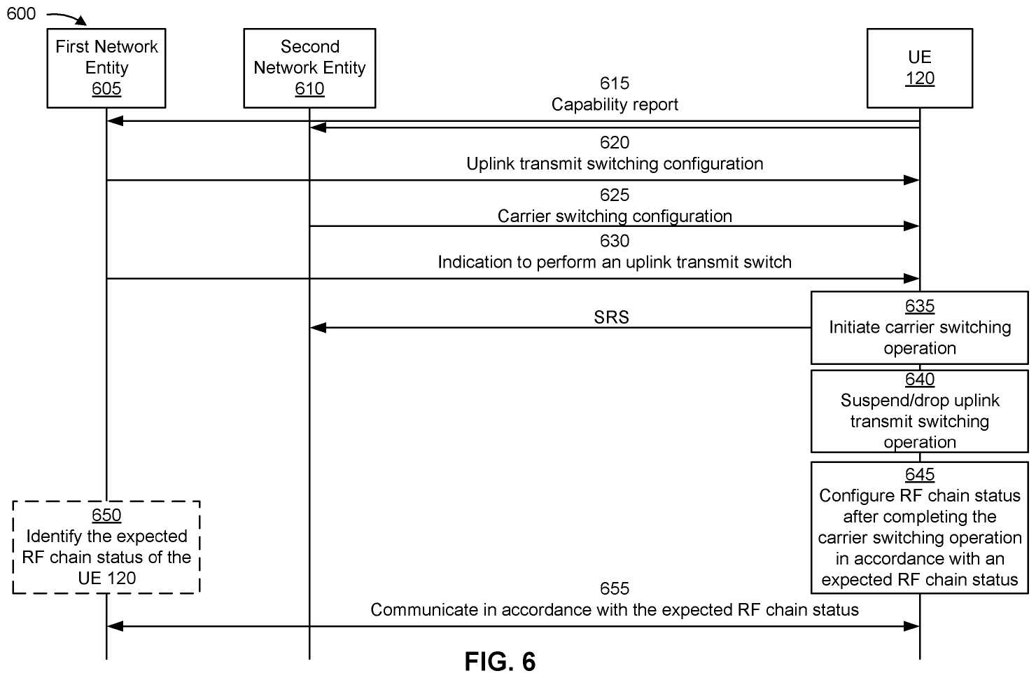

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-12).

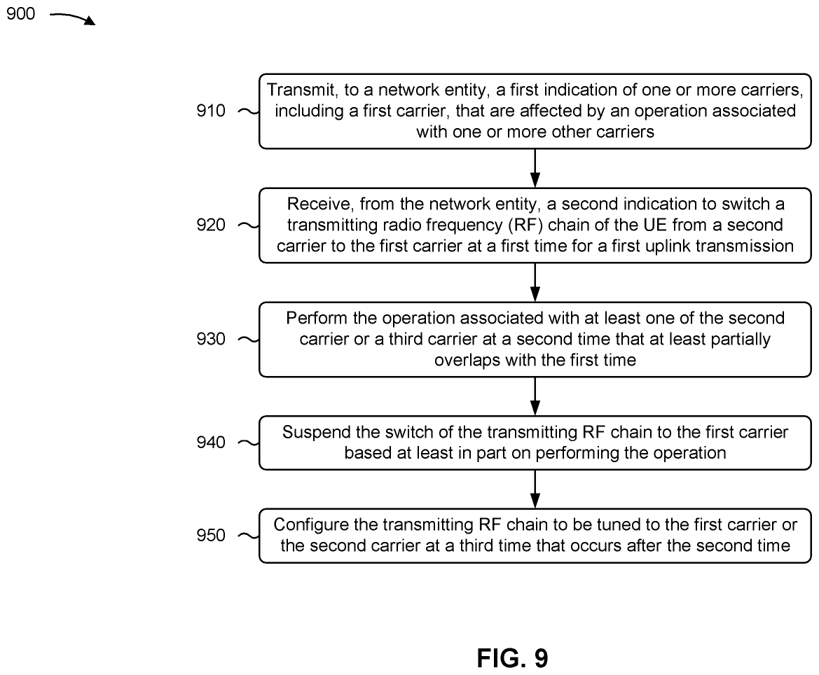

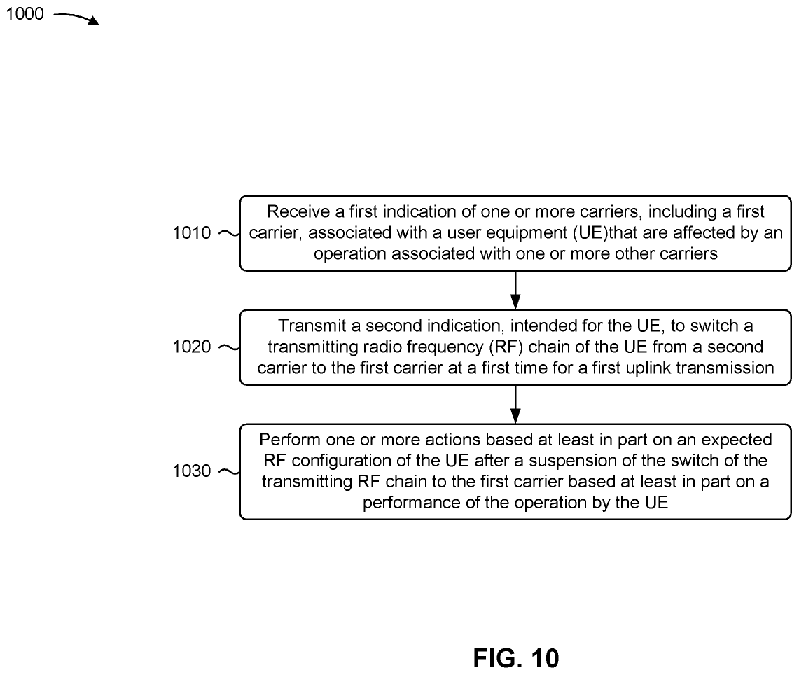

The controller/processor 240 of the base station 110, the controller/processor 280 of the UE 120, and/or any other component(s) of FIG. 2 may perform one or more techniques associated with resuming suspended transmit switching, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for transmitting, to a network entity, a first indication of one or more carriers, including a first carrier, that are affected by an operation associated with one or more other carriers; means for receiving, from the network entity, a second indication to switch a transmitting RF chain of the UE 120 from a second carrier to the first carrier at a first time for a first uplink transmission; means for performing the operation associated with at least one of the second carrier or a third carrier at a second time that at least partially overlaps with the first time; means for suspending the switch of the transmitting RF chain to the first carrier based at least in part on performing the operation; and/or means for configuring the transmitting RF chain to be tuned to the first carrier or the second carrier at a third time that occurs after the second time. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., shown in FIGS. 1 and 2 as a base station 110 as an example) includes means for receiving a first indication of one or more carriers, associated with a UE including a first carrier, that are affected by an operation associated with one or more other carriers; means for transmitting a second indication, intended for the UE, to switch a transmitting RF chain of the UE from a second carrier to the first carrier at a first time for a first uplink transmission; and/or means for performing one or more actions based at least in part on an expected RF configuration of the UE after a suspension of the switch of the transmitting RF chain to the first carrier based at least in part on a performance of the operation by the UE. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

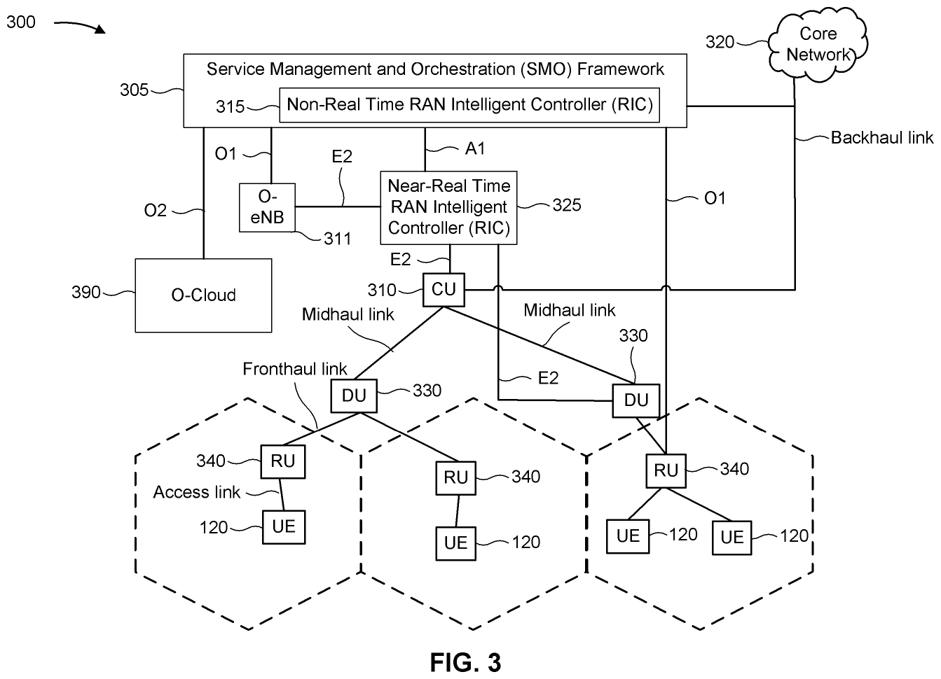

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

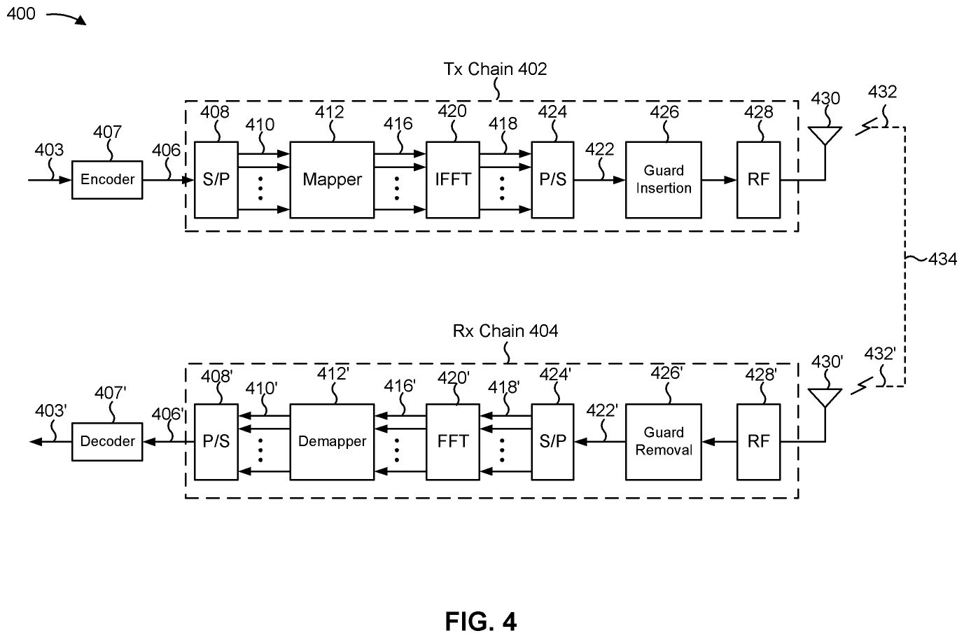

FIG. 4 is a diagram illustrating an example 400 of a transmit (Tx) chain 402 and a receive (Rx) chain 404 of a UE 120, in accordance with the present disclosure. The Tx chain 402 and/or the Rx chain 404 may be radio frequency (RF) chains of the UE 120. The Tx chain 402 may be referred to herein as a transmitting RF chain. Similarly, the Rx chain 404 may be referred to as a receiving RF chain. In some examples, one or more components of Tx chain 402 may be implemented in transmit processor 264, TX MIMO processor 266, modem 254, and/or controller/processor 280, as described above in connection with FIG. 2. In some examples, Tx chain 402 may be implemented in UE 120 for transmitting data 406 (e.g., uplink data, an uplink reference signal, and/or uplink control information) to base station 110 on an uplink channel.

An encoder 407 may alter a signal (e.g., a bitstream) 403 into data 406. Data 406 to be transmitted is provided from encoder 407 as input to a serial-to-parallel (S/P) converter 408. In some examples, S/P converter 408 may split the transmission data into N parallel data streams 410.

The N parallel data streams 410 may then be provided as input to a mapper 412. Mapper 412 may map the N parallel data streams 410 onto N constellation points. The mapping may be done using a modulation constellation, such as binary phase-shift keying (BPSK), quadrature phase-shift keying (QPSK), 8 phase-shift keying (8PSK), and/or quadrature amplitude modulation (QAM), among other examples. Thus, mapper 412 may output N parallel symbol streams 416, each symbol stream 416 corresponding to one of N orthogonal subcarriers of an inverse fast Fourier transform (IFFT) component 420. These N parallel symbol streams 416 are represented in the frequency domain and may be converted into N parallel time domain sample streams 418 by IFFT component 420.

In some examples, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of guard insertion component 426 may then be upconverted to a desired transmit frequency band by an RF front end 428. The RF front end 428 may include one or more RF components, such as one or more filters, one or more power amplifiers, one or more low noise amplifiers, one or more antenna switches (e.g., antenna cross switches), one or more digital-to-analog converters, or one or more analog-to-digital converters, among other examples. An antenna 430 may then transmit the resulting signal 432. For example, the Tx chain 402 may be associated with an antenna port (e.g., an antenna port associated with the antenna 430).

In some examples, Rx chain 404 may utilize OFDM/OFDMA. In some examples, one or more components of Rx chain 404 may be implemented in receive processor 258, MIMO detector 256, modem 254, and/or controller/processor 280, as described above in connection with FIG. 2. In some examples, Rx chain 404 may be implemented in UE 120 for receiving data 406 (e.g., downlink data, a downlink reference signal, and/or downlink control information) from a network entity on a downlink channel.

A transmitted signal 432 is shown traveling over a wireless channel 434 from Tx chain 402 to Rx chain 404. When a signal 432′ is received by an antenna 430′, the received signal 432′ may be downconverted to a baseband signal by an RF front end 428′. A guard removal component 426′ may then remove the guard interval that was inserted between OFDM/OFDMA symbols by guard insertion component 426. The Rx chain 404 may be associated with an antenna port (e.g., the antenna port associated with the antenna 430′).

The output of guard removal component 426′ may be provided to an S/P converter 424′. The output may include an OFDM/OFDMA symbol stream 422′, and S/P converter 424′ may divide the OFDM/OFDMA symbol stream 422′ into N parallel time-domain symbol streams 418′, each of which corresponds to one of the N orthogonal subcarriers. A fast Fourier transform (FFT) component 420′ may convert the N parallel time-domain symbol streams 418′ into the frequency domain and output N parallel frequency-domain symbol streams 416′.

A demapper 412′ may perform the inverse of the symbol mapping operation that was performed by mapper 412, thereby outputting N parallel data streams 410′. A P/S converter 408′ may combine the N parallel data streams 410′ into a single data stream 406′. Ideally, data stream 406′ corresponds to data 406 that was provided as input to Tx chain 402. Data stream 406′ may be decoded into a decoded data stream 403′ by decoder 407′.

In some examples, the Tx chain 402 and/or the Rx chain 404 may be tuned to an operating frequency (e.g., associated with a frequency band in which the UE 120 is operating). As used herein, “tuning” may refer to configuring or adjusting RF components (e.g., components included in the Tx chain 402, the Rx chain 404, the RF front end 428, and/or the RF front end 428′) to operate at a particular frequency and/or within a particular frequency range. For example, the UE 120 may be configured to operate using one or more carriers (e.g., one or more component carriers (CCs)). A carrier, or CC, may be a set of frequency domain resources (e.g., of 10 MHz, 20 MHz, 30 MHz, 50 MHz, and/or other frequency ranges). Each carrier may be associated with an operating frequency and/or a range of frequencies (e.g., with a frequency band, such as a frequency band defined, or otherwise fixed, for a carrier or CC by a wireless communication standard, such as the 3GPP). If the UE 120 is to transmit or receive via a particular carrier, then the UE 120 may tune RF components of the UE 120 to an operating frequency and/or a range of frequencies associated with the particular carrier to enable the UE 120 to transmit and/or receive communications via the particular carrier.

Carrier aggregation is a technology that enables two or more carriers or CCs, to be combined (e.g., into a single channel) for a single UE 120 to enhance data capacity. Carriers can be combined in the same or different frequency bands. Additionally, or alternatively, contiguous or non-contiguous carriers can be combined. A network entity may configure carrier aggregation for a UE 120, such as in a radio resource control (RRC) message, downlink control information (DCI), and/or another signaling message.

In some examples, carrier aggregation may be configured in an intra-band contiguous mode where the aggregated carriers are contiguous to one another and are in the same band. In some examples, carrier aggregation may be configured in an intra-band non-contiguous mode where the aggregated carriers are non-contiguous to one another and are in the same band. In some examples, carrier aggregation may be configured in an inter-band non-contiguous mode where the aggregated carriers are non-contiguous to one another and are in different bands.

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally, or alternatively, a set of components (e.g., one or more components) shown in FIG. 4 may perform one or more functions described as being performed by another set of components shown in FIG. 4.

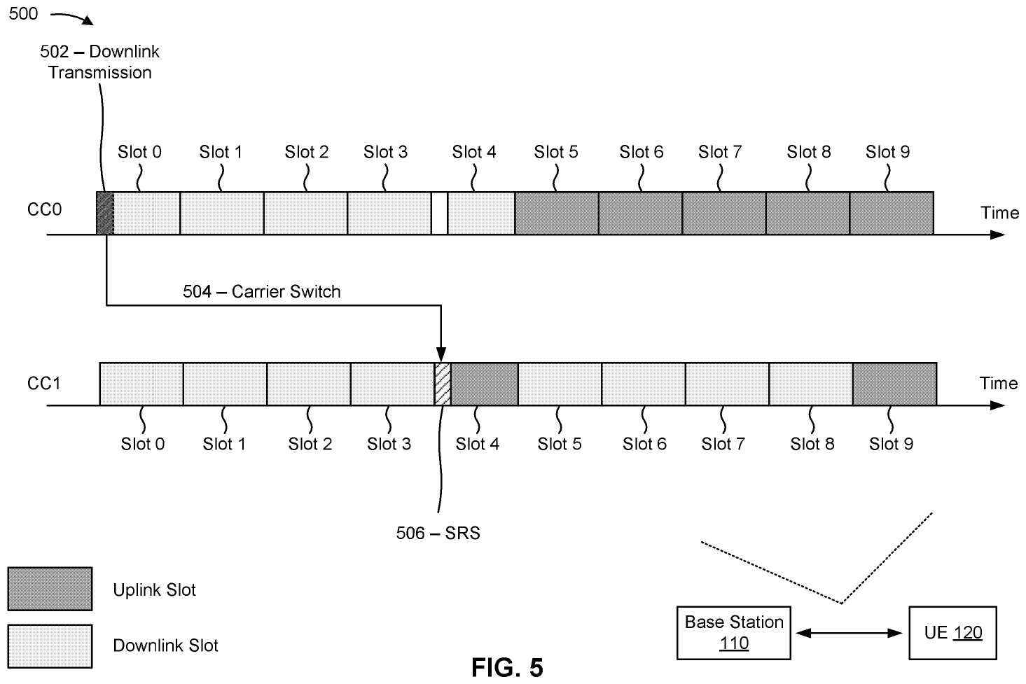

FIG. 5 is diagram illustrating an example 500 of carrier switching. The example 500 may include communication between a UE 120 and a base station 110 described in connection with FIGS. 1 and 2, or between a UE 120 and other types of wireless communication devices (including network entities or network notes such as a DU 330, an RU 340, or a CU 310 described in connection with FIG. 3), among other examples. As shown in FIG. 5, the base station 110 and the UE 120 may communicate in one or more slots in a wireless network such as the wireless network 100. For example, the base station 110 and the UE 120 may communicate in one or more of slots 0-9. However, the base station 110 and the UE 120 may communicate across a different quantity of slots. Moreover, the UE 120 may communicate in one or more of the slots with another network entity or network node such as a CU 310, a DU 330, an RU 340, or another network entity. Additionally or alternatively, the base station 110 may be implemented by or may include one or more of a CU 310, a DU 330, an RU 340, or another network entity described in connection with FIG. 3 or elsewhere herein.

As further shown in FIG. 5, the UE 120 and the base station 110 may communicate on a plurality of component carriers such as CC0 and CC1. However, the UE 120 and the base station 110 may communicate on a different quantity of component carriers. A component carrier may include a subset of a frequency range of a bandwidth part (BWP) allocated for communication between the UE 120 and the base station 110. In some cases, the plurality of component carriers may be included in the same BWP or in different BWPs.

For example, in a time division duplexed (TDD) multiple-input multiple-output (MIMO) network, a reference signal (e.g., a sounding reference signal (SRS) or another reference signal) may be used for reciprocity-based beamforming. The UE 120 may transmit the reference signal on the uplink. The base station 110 may estimate the channel using the reference signal, and may perform beamforming or precoding for the downlink based at least in part on the estimated channel. In some cases, the CC0 may be a primary cell or a primary CC of the UE 120. For example, the CC0 may be a CC or carrier of the UE 120 on which the UE 120 is configured to transmit SRSs for a base station 110. SRS carrier switching may enable the base station 110 (or another network entity) to obtain channel state information (CSI) associated with a second cell or CC (e.g., the CC1) in some carrier aggregation scenarios. For example, without performing the SRS carrier switching, the UE 120 may only transmit SRSs via the CC0. Therefore, the base station 110 may transmit downlink communications to the UE 120 via the CC1 without obtaining CSI associated with the CC1 (e.g., because the UE 120 may not transmit any SRSs via the CC1). In other words, SRS carrier switching enables the UE 120 to transmit SRSs on non-SRS carriers to enable the base station 110 to obtain CSI associated with the non-SRS carriers.

In some cases, the UE 120 may have transmit components and receive components, such as antennas, transmit chains, receive chains, RF front-ends, and/or other components (e.g., such as those described in connection with FIG. 4). In many cases, the UE 120 may have asymmetric transmit components and receive components. As one example, the UE 120 may have multiple antennas and a single transmit chain, meaning that the UE can only transmit using one of the multiple antennas. As a second example, the UE 120 may support 3 bands for downlink carrier aggregation, but may have a single transmit chain (or less than 3 transmit chains), meaning that less than all of the 3 bands can be used for uplink transmissions (e.g., because the UE 120 may only be able to tune a transmit chain to some, but not all, of the bands or carriers configured to the UE 120). This asymmetry may limit the reciprocity-based operation, because the base station may not be able to estimate all channels or carriers configured for the UE 120. This may be because the base station 110 may only be able to estimate a channel in which the UE can transmit a reference signal.

As further shown in FIG. 5, carrier switching between the component carriers may be supported and enabled for the UE 120. Carrier switching may include SRS carrier switching, where SRS resources may be scheduled on both component carriers, which results in the UE 120 switching between CC0 and CC1 to use the SRS resources on different component carriers. Other types of carrier switching are also possible, such as physical uplink control channel (PUCCH) carrier switching, among other examples. Carrier switching may be dynamically indicated by the base station 110 in DCI, may be semi-statically configured for the UE 120 in an RRC configuration or in a medium access control channel (MAC) control element (MAC-CE), or a combination thereof. In some cases, semi-static SRS carrier switching may be based on an RRC-configured semi-static time domain cell pattern of applicable SRS cells (or component carriers), and may support switching across SRS cells (or component carriers) with different numerologies.

A semi-static time domain SRS pattern may include a pattern (that is semi-static) of SRS resources on two or more component carriers that result in a UE 120 switching between the two or more component carriers to use the SRS resources. As an example, a semi-static time domain SRS pattern may include SRS resources in a first slot on a first component carrier, may include SRS resources in a second slot (subsequent to the first slot) on a second component carrier, may include SRS resources in a third slot (subsequent to the second slot) on the first component carrier, and so on. Thus, a UE 120 configured with the example semi-static time domain SRS pattern may use the SRS resources in the first slot on the first component carrier, may perform a carrier switch to switch from the first component carrier to the second component carrier to use the SRS resources in the second slot, may perform a carrier switch to switch from the second component carrier to the first component carrier to use the SRS resources in the third slot, and so on.

As an example of the above, as shown by reference number 502, the base station 110 may transmit a downlink transmission to the UE 120. The UE 120 may receive the downlink transmission on the CC0. As shown by reference number 504, the UE 120 may perform a carrier switch after receiving the downlink transmission on the CC0. The carrier switch may include switching from the CC0 to the CC1. The carrier switch may include tuning or adjusting the modem 254, the antennas 252, a transmitting RF chain, an RF front end, other hardware of the UE 120, or a combination thereof to operate on the frequency range of the CC1. As shown by reference number 506, the UE 120 may transmit an SRS using an SRS resource in Slot 4 on the CC1.

The UE 120 may perform carrier switching in accordance with a carrier switching capability (sometimes referred to herein as a capability for carrier switching). For example, the carrier switching capability may indicate, per band in a band combination, a switching time to switch from a carrier on one band to a carrier on another band of the band combination. In some aspects, the switching time may be for transmission of a reference signal. For example, consider a band combination of B1/B2/B3/B4 (band may be used interchangeably herein with carrier). In this case, the carrier switching capability may indicate that the uplink of B1 can switch to B3 with an uplink interruption of 1 symbol (e.g., 1 OFDM symbol) and no downlink interruption, that the uplink of B1 can switch to B4 with an uplink interruption of 2 symbols and a downlink interruption of 1 symbol, and so on. In some examples, carrier switching capabilities may be provided for each switchable band of the band combination (e.g., each possible pairing of source band and target band), and/or may be provided for multiple band combinations. “Carrier combination” is used interchangeably with “band combination” herein.

In some cases, the UE 120 may also be enabled to perform dynamic uplink transmit switching (e.g., as defined, or otherwise fixed, by a wireless communication standard, such as by 3GPP Technical Specification 38.306 Version 16.3.0 or another 3GPP Technical Specification). For example, the UE 120 may be associated with two transmitting RF chains (e.g., the UE 120 may be a 2Tx UE). A base station 110 (or another network entity) may dynamically indicate to a UE 120 to switch a Tx chain from a first carrier (e.g., a first CC) to a second carrier (e.g., a second CC) for an uplink transmission. For example, a Tx chain of the UE 120 may be configured or tuned to a first CC. The base station 110 may transmit, to the UE 120, DCI scheduling an uplink transmission on a second CC. The UE 120 may configure or tune (e.g., switch) the Tx chain from the first CC to the second CC to transmit the uplink transmission based on receiving the indication from the base station 110.

In some cases, one or more carriers or bands associated with dynamic uplink transmit switching may be affected by another operation of the UE 120, such as a carrier switching operation, among other examples. For example, the UE 120 may be capable of performing SRS carrier switching associated with a first set of bands or carriers. In some aspects, the UE 120 may transmit, to a network entity, an indication of bands or carriers that are affected by an SRS carrier switching operation (e.g., for each band pair (e.g., as indicated by an srs-SwitchingTimesListNR or similar parameter) the UE 120 may indicate which other bands in a band combination are affected by the SRS switch). As used herein, a band or carrier that is “affected” by an SRS carrier switching operation may refer to a band or carrier that is not associated with the SRS carrier switching operation (e.g., is not included in bands or carriers that are switched to), but on which the UE 120 is unable to transmit uplink communications when an SRS carrier switching operation is ongoing. For example, the UE 120 may perform an SRS carrier switching on CC0 and CC1 (e.g., as depicted in FIG. 5). A CC2 (e.g., not shown in FIG. 5) may be associated with one or more common Tx chains, RF front end components, and/or antennas as the CC0 and the CC1. Therefore, if the UE 120 is transmitting an SRS on the CC0 or the CC1, the UE 120 may be unable to transmit uplink communications via the CC2 (e.g., because the one or more common Tx chains, RF front end components, and/or antennas are tuned to, or are being used for, the carrier switching operation).

In some cases, the UE 120 may be capable of performing dynamic uplink transmit switching using bands or carriers that are also associated with, or affected by, a carrier switching operation. For example, the UE 120 may be capable of dynamically switching a Tx chain or antenna port between the CC1 and the CC2. In some cases, the UE 120 may be indicated to switch a Tx chain or antenna port to another CC at a same time as, or at a time that at least partially overlaps with, another operation, such as a carrier switching operation. In such examples, the UE 120 may be unable to perform the dynamic uplink transmit switch due to the other operation, such as a carrier switching operation (e.g., the carrier switching operation may be associated with a higher priority than the dynamic uplink transmit switching operation). Therefore, the UE 120 may suspend or drop (e.g., refrain from performing) the dynamic uplink transmit switching operation (e.g., between the CC1 and the CC2) based at least in part on the dynamic uplink transmit switching operation at least partially overlapping in time with an SRS carrier switching operation (e.g., associated with the CC0 and the CC1).

In some cases, the dynamic uplink transmit switching operation may be associated with a first base station (or first network entity) and the SRS carrier switching operation may be associated with a second base station (or second network entity). In some cases, the first base station and the second base station may not communicate to indicate different operations associated with the UE 120. Therefore, the first base station may not receive an indication that the SRS carrier switching operation is ongoing and/or that the uplink transmit switching operation was suspended and/or not performed by the UE 120. As a result, the first base station may expect that the UE 120 (e.g., the Tx chain or RF front end of the UE 120) is configured or tuned as indicated by the indication triggering the uplink transmit switching operation (e.g., tuned to the CC2). However, if the UE 120 does not configure or tune the Tx chain or RF front end of the UE 120 as indicated by the first base station, then there may be a misalignment between the UE 120 and the first base station. If the first base station subsequently schedules another uplink transmission on the CC to which the UE 120 was to switch (e.g., the CC2), then there may be an unexpected interruption or dropping of the other uplink transmission. For example, the first base station may schedule the UE 120 assuming that the Tx chain or RF front end of the UE 120 is tuned to the CC2. However, the UE 120 may require some time to tune the Tx chain or RF front end to the CC2 because the uplink transmit switching was suspended or dropped due to the SRS carrier switching operation. If the first base station schedules the uplink transmission on the CC2 without enough time for the UE 120 to switch (e.g., tune) the Tx chain or RF front end to the CC2, the UE 120 may delay or drop the uplink transmission. This may result in degraded communication performance and/or reduced throughput for the UE 120, among other examples.

Some techniques and apparatuses described herein enable resuming suspended transmit switching. For example, some techniques and apparatuses described herein are associated with synchronizing an expected RF state (e.g., a state of an RF front end) of a UE between the UE and a network entity when the UE suspends or drops an uplink transmit switching operation. For example, the UE 120 may transmit an indication of one or more carriers, including a first carrier, that are affected by an operation associated with one or more other carriers. For example, the operation may include an SRS carrier switching operation or another operation. The UE 120 may receive an indication to switch a transmitting RF chain or antenna port of the UE from a second carrier to the first carrier at a first time for a first uplink transmission. The UE 120 may perform the operation associated with at least one of the second carrier or a third carrier at a second time that at least partially overlaps with the first time. The UE 120 may suspend the switch of the transmitting RF chain to the first carrier based at least in part on performing the operation. The UE 120 may configure the transmitting RF chain to be tuned to the first carrier or the second carrier at a third time that occurs after the second time.

In other words, after suspending the uplink transmit switch, the UE 120 may be expected to have the same RF chain status as indicated by the suspended switching scheduling (e.g., as indicated in the indication to switch the transmitting RF chain or the antenna port). Alternatively, the UE 120 may be expected to have the original RF chain status without the suspended switching scheduling (e.g., to have the RF chain status of the UE 120 before the UE 120 received the indication to switch the transmitting RF chain or the antenna port). By defining the expected RF chain status of the UE 120 after the UE 120 suspends or drops an uplink transmit switch, a network entity that transmitted the indication triggering the uplink transmit switch may be enabled to perform future scheduling of the UE 120 in accordance with the expected RF chain status. This may improve scheduling determinations made by the network entity. Additionally, this may reduce unexpected delays or interruptions in scheduled communications that would otherwise be caused by the UE 120 switching the RF chain status to an RF chain status assumed by the network entity (e.g., assumed by the network entity when making the scheduling determinations) after receiving the scheduling.

FIG. 6 is a diagram of an example 600 associated with resuming suspended transmit switching, in accordance with the present disclosure. As shown in FIG. 6, a first network entity 605 (e.g., a base station 110, a CU, a DU, and/or an RU), a second network entity 610 (e.g., a base station 110, a CU, a DU, and/or an RU) may communicate with a UE (e.g., a UE 120). In some aspects, the first network entity 605, the second network entity 610, and the UE 120 may be part of a wireless network (e.g., the wireless network 100). The UE 120 and the first network entity 605 and/or the second network entity 610 may have established a wireless connection prior to operations shown in FIG. 6. In some aspects, the first network entity 605 and the second network entity 610 may be co-located and/or may communicate with each other. In some other aspects, the first network entity 605 and the second network entity 610 may not be co-located and/or may not communicate with one another. In some aspects, a single device (e.g., a single network entity or base station) may perform the operations described herein associated with the first network entity 605 and the second network entity 610.

As shown by reference number 615, the UE 120 may transmit a capability report. The first network entity 605 may receive the capability report (e.g., from the UE 120 or from another network entity). The second network entity 610 may receive the capability report (e.g., from the UE 120 or another network entity). In some aspects, the capability report may indicate UE support for carrier switching (e.g., SRS carrier switching), uplink transmit switching, and/or one or more other operations. In some aspects, the capability report may indicate one or more carriers or bands on which the UE 120 supports carrier switching. For example, the UE 120 may indicate one or more pairs or combinations of carriers or bands on which the UE 120 supports carrier switching. Additionally, or alternatively, the capability report may indicate one or more carriers or bands on which the UE 120 supports uplink transmit switching. For example, the UE 120 may indicate one or more pairs or combinations of carriers or bands on which the UE 120 supports uplink transmit switching. In other words, the UE 120 may transmit a capability indication associated with a first one or more carriers that are supported by the UE 120 for uplink transmit switching. The UE 120 may transmit an indication of a second one or more carriers associated with the operation (e.g., the SRS carrier switching operation), where the first one or more carriers (e.g., that are supported by the UE 120 for uplink transmit switching) and the second one or more carriers (e.g., that are associated with or affected by the operation) include at least one common carrier. In some aspects, performing operations described in more detail herein may be based at least in part on the first one or more carriers (e.g., that are supported by the UE 120 for uplink transmit switching) and the second one or more carriers (e.g., that are associated with or affected by the operation) including at least one common carrier.

In some aspects, the UE 120 may transmit an indication of one or more carriers that are affected by an operation associated with one or more other carriers. The operation may include the SRS carrier switching operation or another operation that affects or impacts uplink transmissions by the UE 120 on other carriers or bands (e.g., that are not used to perform the operation). For example, the UE 120 may indicate a list of CCs or bands that are affected by an SRS carrier switching operation associated with a source target pair of CCs or bands. For example, as part of the capability report, the UE 120 may indicate one or more pairs of bands on which the UE 120 supports SRS carrier switching (e.g., and for each particular pair of bands, an RF retuning time when switching between a carrier corresponding to the particular pair of bands and another carrier in an indicated band list). For each indicated pair of bands, the UE 120 may indicate a list of bands or carriers that are affected by an SRS carrier switching operation associated with the indicated pair of bands.

In some aspects, a priority rule (e.g., defined by a wireless communication standard, such as the 3GPP, or indicated to the UE 120 by a network entity) may indicate that the UE 120 is not to perform uplink transmissions or operations while the operation (e.g., the SRS carrier switching operation) is ongoing. In some aspects, the UE 120 may support uplink transmit switching associated with a band or carrier that is affected by the operation (e.g., the SRS carrier switching operation). Therefore, when the UE 120 is performing the operation (e.g., the SRS carrier switching operation), the priority rule may extend to the bands or carriers associated with uplink transmit switching, such that the UE 120 may not perform uplink transmissions or operations while the operation on the bands or carriers associated with the operation (e.g., the SRS carrier switching operation) is ongoing.

As shown by reference number 620, the UE 120 may receive an uplink transmit switching configuration (e.g., from the first network entity 605 or from another network entity). The first network entity 605 may transmit the uplink transmit switching configuration (e.g., to the UE 120 or to another network entity). In some aspects, the UE 120 may receive the uplink transmit switching configuration via one or more of RRC signaling, one or more MAC-CEs, and/or DCI, among other examples. In some aspects, the uplink transmit switching configuration may include an indication of one or more configuration parameters (e.g., already stored by the UE 120 and/or previously indicated by the first network entity 605 or other network device) for selection by the UE 120, and/or explicit configuration information for the UE to use to configure the UE 120, among other examples.

In some aspects, the uplink transmit switching configuration may indicate that the UE 120 is to perform uplink transmit switching between one or more bands or carriers (e.g., as indicated or scheduled by the first network entity 605). For example, the uplink transmit switching configuration may indicate that the UE 120 is configured to perform uplink transmit switching between a first carrier (e.g., CC1) and a second carrier (e.g., CC2), among other examples. In some aspects, the first carrier and the second carrier may be affected by the operation (e.g., the SRS carrier switching operation). For example, the capability indication transmitted by the UE 120 may indicate that the first carrier and the second carrier are affected by an SRS carrier switching operation associated with a particular band pair or carrier pair. For example, the band pair or carrier pair may include the second carrier (e.g., CC2) and a third carrier (e.g., CC3). For example, when the UE 120 is configured to perform SRS carrier switching associated with the CC2 and the CC3, the UE 120 may be unable to perform uplink transmissions or operations associated with the CC1.

The UE 120 may configure itself based at least in part on the uplink transmit switching configuration. In some aspects, the UE 120 may be configured to perform one or more operations described herein based at least in part on the uplink transmit switching configuration.

As shown by reference number 625, the UE 120 may receive a carrier switching configuration (e.g., from the second network entity 610 or from another network entity). The second network entity 610 may transmit the carrier switching configuration (e.g., to the UE 120 or to another network entity). In some aspects, the UE 120 may receive the carrier switching configuration via one or more of RRC signaling, one or more MAC-CEs, and/or DCI, among other examples. In some aspects, the carrier switching configuration may include an indication of one or more configuration parameters (e.g., already stored by the UE 120 and/or previously indicated by the first network entity 605 or other network device) for selection by the UE 120, and/or explicit configuration information for the UE to use to configure the UE 120, among other examples.

In some aspects, the carrier switching configuration may indicate that the UE 120 is to perform SRS carrier switching (or another type of carrier switching) between one or more bands or carriers. For example, the carrier switching configuration may indicate that the UE 120 is configured to perform SRS carrier switching between the second carrier (e.g., CC2) and the third carrier (e.g., CC3). In some aspects, the carrier switching configuration may indicate a semi-static or periodic schedule associated with performing the SRS carrier switching. For example, the carrier switching configuration may indicate a configuration for one or more SRS resources to be used by the UE 120 to perform the SRS carrier switching. The SRS resources may be periodic SRS resources or semi-persistent SRS resources, among other examples.

The UE 120 may configure itself based at least in part on the carrier switching configuration. In some aspects, the UE 120 may be configured to perform one or more operations described herein based at least in part on the carrier switching configuration.

As shown by reference number 630, the UE 120 may receive an indication to perform uplink transmit switching from the CC2 to the CC1 at a first time. The first network entity 605 may transmit the indication to perform uplink transmit switching (e.g., to the UE 120 or to another network entity). For example, the UE 120 may receive an indication to switch a transmitting RF chain or antenna port of the UE 120 from the second carrier to the first carrier at the first time for a first uplink transmission. The indication may be included in DCI transmitted by the first network entity 605. The DCI may schedule a transmission of the first uplink transmission on the CC1. In some aspects, the UE 120 may receive the indication via the first carrier or the second carrier. At a time when the UE 120 receives the indication to perform uplink transmit switching, the RF front end of the UE 120 may be configured with one transmitting RF chain tuned to the CC2 and one transmitting RF chain tuned to the CC1. The indication may indicate that, to perform the first uplink transmission, the UE 120 is to switch or tune the transmitting RF chain tuned to the CC2 to the CC1.

As shown by reference number 635, the UE 120 may initiate the operation that affects operations on the CC1. For example, the UE 120 may initiate an SRS carrier switching operation associated with the CC2 and the CC3. In other words, the UE 120 may perform the operation (e.g., the SRS carrier switching operation) associated with at least one of the second carrier or the third carrier at a second time. For example, the UE 120 may perform the SRS carrier switching operation in accordance with a periodic schedule (e.g., as indicated by the carrier switching configuration). The second time may at least partially overlap with the first time. For example, the UE 120 may perform the SRS carrier switching operation from a time T1 to T2 (e.g., which may include a transmission time of the SRS and a tuning/retuning time of the UE 120). The UE 120 may be scheduled to transmit the first uplink transmission (e.g., associated with the uplink transmit switching operation) from a time T3 to T4. The first time T3 to T4 may at least partially overlap with the second time T1 to T2.

Therefore, as shown by reference number 640, the UE 120 may suspend or drop (e.g., refrain from performing) the uplink transmit switching operation as indicated or scheduled by the first network entity 605. For example, the UE 120 may suspend the switch of the transmitting RF chain to the first carrier based at least in part on performing the operation (e.g., the SRS carrier switching operation) at a time that at least partially overlaps with the time associated with the switch of the transmitting RF chain to the first carrier. For example, the UE 120 may suspend or drop the uplink transmit switching operation based at least in part on the priority rule associated with the operation (e.g., the SRS carrier switching operation). For example, as described above, the priority rule may indicate that the UE 120 is to suspend or drop transmission operations on bands or carriers associated with an SRS carrier switching operation while the SRS carrier switching operation is ongoing. The priority rule may be defined, or otherwise fixed, by a wireless communication standard, such as the 3GPP (e.g., and stored by the UE 120 as part of an original equipment manufacturer (OEM) configuration). Additionally, or alternatively, the priority rule may be indicated by the second network entity 610 (e.g., in the carrier switching configuration).

Performing the SRS carrier switching operation may include tuning the RF front end and/or a transmitting RF chain of the UE 120 from the CC2 to the CC3, transmitting an SRS via the CC3, and tuning (retuning) the RF front end and/or the transmitting RF chain of the UE 120 from the CC3 back to the CC2. During this time, the UE 120 may refrain from performing other operations (such as the uplink transmit switching operation) associated with CCs or bands that are affected by the SRS carrier switching operation, such as the CC1, the CC2, and the CC3, among other examples.

In some aspects, the UE 120 may transmit an indication that the switch of the transmitting RF chain to the first carrier has been suspended or dropped. The first network entity 605 may receive the indication that the switch of the transmitting RF chain to the first carrier has been suspended or dropped. As a result, the first network entity 605 may be enabled to perform one or more actions based at least in part on an expected RF configuration or status of the UE after a suspension of the switch of the transmitting RF chain to the first carrier based at least in part on a performance of the operation by the UE 120, as explained in more detail elsewhere herein.

As shown by reference number 645, the UE 120 may configure the transmitting RF chain to be tuned to the first carrier (CC1) or the second carrier (CC2) at a third time that occurs after the second time (e.g., that occurs after the SRS carrier switching operation has been completed). For example, the UE 120 may configure or tune the transmitting RF chain to an expected RF chain status after the SRS carrier switching operation has been completed. The “expected” RF chain status or configuration may be a status of the transmitting RF chain after a suspension or dropping of an uplink transmit switching operation due to the performance of another operation, such as the SRS carrier switching operation. In some aspects, the expected RF status of the UE 120 may be defined, or otherwise fixed, by a wireless communication standard, such as the 3GPP. In such examples, the UE 120 may autonomously configure or tune the transmitting RF chain in accordance with the expected RF status (e.g., without receiving a configuration or indication from a network entity to configure or tune the transmitting RF chain in accordance with the expected RF status). In some other examples, the expected RF status of the UE 120 may be indicated or configured by a network entity (e.g., the first network entity 605, the second network entity 610, or another network entity).

In some aspects, the expected RF chain status or configuration may be the RF chain status or configuration indicated by the suspended uplink transmit switching operation. For example, after suspending or dropping an uplink transmit switching operation (e.g., due to a collision or overlap with another operation, such as the SRS carrier switching operation), the UE 120 may be expected to resume the uplink transmit switching per the first network entity's 605 scheduling (e.g., indicated as described above in connection with reference number 630) after the SRS carrier switching operation has been performed. For example, the UE 120 may autonomously switch or tune the transmitting RF chain or antenna port from the CC2 to the CC1 after the SRS carrier switching operation has been performed. In some aspects, configuring or tuning the RF front end and/or transmitting RF chain to the RF chain status indicated by the uplink transmit switching scheduling may be based at least in part on an amount of time between a completion of the SRS carrier switching operation and a next scheduled uplink transmission satisfying a threshold. The threshold may be based at least in part on an amount of time needed by the UE 120 to tune or configure the RF front end and/or transmitting RF chain.

In some aspects, the UE 120 may transmit the first uplink transmission or another uplink transmission based at least in part on configuring the transmitting RF chain to the first carrier (e.g., where the expected RF chain status or configuration is the RF chain status indicated by the uplink transmit switching scheduling). In some other aspects, the UE 120 may configure or tune the RF front end and/or transmitting RF chain as indicated by the uplink transmit switching scheduling, but may not transmit the uplink communication scheduled by the uplink transmit switching scheduling (e.g., due to a budget time or a scheduled transmission time passing).

As another example, the expected RF chain status or configuration may be the RF chain status or configuration of the UE 120 prior to receiving the uplink transmit switching indication (e.g., prior to receiving the indication as described above in connection with reference number 630). For example, the UE 120 may be expected to maintain the original RF chain status of the UE 120 without the suspended switching scheduling (e.g., ignoring the suspended switching scheduling). In such examples, the UE 120 may autonomously keep the transmitting RF chain or antenna port tuned to the CC2 (e.g., rather than switching or tuning to the CC1 as indicated by the uplink transmit switch scheduling). In such examples, the UE 120 refrain from transmitting (e.g., may drop) the uplink communication scheduled by the uplink transmit switching scheduling.

In some aspects, as shown by reference number 650, the first network entity 605 may identify the expected RF chain status of the UE 120. For example, the first network entity 605 may identify the expected RF chain status of the UE 120 based at least in part on identifying that the SRS carrier switching operation is performed by the UE 120 at a time that at least partially overlaps with the time associated with performing the uplink transmit switching operation. For example, the first network entity 605 may identify the expected RF chain status based at least in part on the expected RF chain status being predefined (e.g., by a wireless communication standard), on receiving an indication that the SRS carrier switching operation is being performed at a time that at least partially overlaps with a time associated with the uplink transmit switching operation, and/or on receiving an indication from the UE 120 that the uplink transmit switching operation has been suspended or dropped, among other examples. For example, the first network entity 605 may identify that the uplink transmit switching operation has been suspended or dropped by the UE 120 based at least in part on not receiving the uplink communication scheduled by the first network entity 605 (e.g., associated with the uplink transmit switching operation). Therefore, the first network entity 605 may identify that the RF chain status or configuration of the UE 120 is the expected RF chain status or configuration.

In some other aspects, the configuration of the RF front end and/or transmitting RF chain of the UE 120 after the suspension of the uplink transmit switching operation may be transparent to (e.g., may not be known by) the first network entity 605. The autonomous configuration of the RF front end and/or transmitting RF chain of the UE 120 after the suspension of the uplink transmit switching operation may ensure that the configuration of the RF front end and/or transmitting RF chain of the UE 120 after the suspension of the uplink transmit switching operation is consistent and predictable.

As shown by reference number 655, the first network entity 605 and the UE 120 may communicate in accordance with the expected RF chain status. For example, the first network entity 605 may perform one or more actions based at least in part on the expected RF configuration of the UE 120 after the suspension of the switch of the transmitting RF chain to the first carrier based at least in part on a performance of the operation (e.g., the SRS carrier switching) by the UE 120. For example, the first network entity 605 may refrain from scheduling any uplink transmissions associated with the UE 120 for a threshold amount of time after the performance of the operation by the UE 120 has ended. The threshold amount of time may be based at least in part on a tuning time or a tuning capability of the UE 120. For example, the first network entity 605 may refrain from scheduling communications associated with the UE 120 for the threshold amount of time after the SRS carrier switching operation has completed to allow the UE 120 enough time to switch or tune the RF front end and/or transmitting RF chain to the expected RF chain status or configuration. This may ensure that no communications are interrupted or are dropped due to the UE 120 tuning the RF front end and/or transmitting RF chain to the expected RF chain status or configuration.

In some aspects, the UE 120 may transmit one or more communications to the first network entity 605 via the first carrier (e.g., the CC1) based at least in part on configuring the RF front end and/or transmitting chain of the UE 120 in accordance with the expected RF chain status or expected RF chain configuration. By defining the expected RF chain status of the UE 120 after the UE 120 suspends or drops an uplink transmit switch, a network entity that transmitted the indication triggering the uplink transmit switch may be enabled to perform future scheduling of the UE 120 in accordance with the expected RF chain status. This may improve scheduling determinations made by the first network entity 605. Additionally, this may reduce unexpected delays or interruptions in scheduled communications that would otherwise be caused by the UE 120 switching the RF chain status to an RF chain status assumed by the first network entity 605 (e.g., assumed by the network entity when making the scheduling determinations) after receiving the scheduling.

As indicated above, FIG. 6 is provided as an example. Other examples may differ from what is described with respect to FIG. 6.

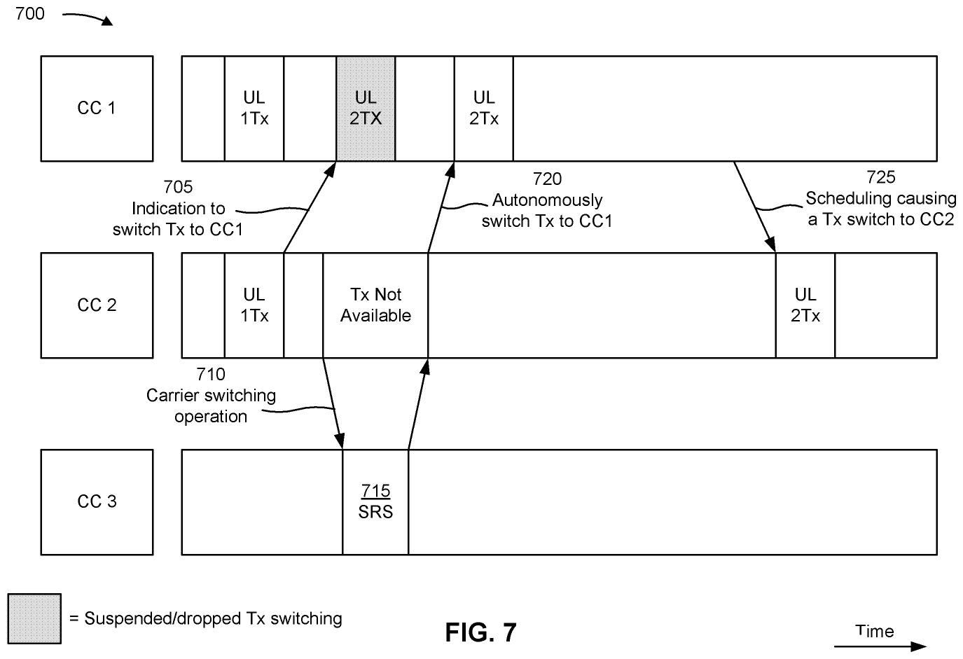

FIG. 7 is a diagram of an example 700 associated with resuming suspended transmit switching, in accordance with the present disclosure. The example 700 may be associated with an expected RF chain status of a UE 120 after a suspension of an uplink transmit switching operation (e.g., as described in more detail elsewhere herein) being the RF chain status as indicated by the uplink transmit switching operation. The UE 120 may be configured with 3 carriers or bands, such as the CC1, the CC2, and the CC3 (e.g., in a similar manner as described in connection with FIG. 6). The CC2 and the CC3 may be associated with an SRS carrier switching operation. The CC1 and the CC2 may be associated with an uplink transmit switching operation. In some aspects, the CC1 may be affected by the SRS carrier switching operation. In some aspects, the CC1 may be associated with (or scheduled by) a first network entity (e.g., the first network entity 605) and the CC2 and the CC3 may be associated with (or scheduled by) a second network entity (e.g., the second network entity 610).

For example, as shown in FIG. 7, an initial RF chain status of the UE 120 may include a first transmitting RF chain being tuned to the CC1 and a second transmitting RF chain being tuned to the CC2 (e.g., as shown by UL 1Tx on CC1 and UL 1Tx on CC2). As shown by reference number 705, the UE 120 may receive an indication to perform uplink transmit switching (e.g., to switch a transmitting RF chain or antenna port from the CC2 to the CC1). As shown by reference number 710, the UE 120 may perform an SRS carrier switching operation at a time that at least partially overlaps with the uplink transmit switching operation. For example, as shown by reference number 715, the UE 120 may transmit an SRS via the CC3 as part of the SRS carrier switching operation.

Because the CC2 and the CC1 may be affected by the SRS carrier switching operation (e.g., as described in more detail elsewhere herein), transmitting operations may be unavailable via the CC2 and the CC1 while the SRS carrier switching operation is ongoing. Therefore, as shown in FIG. 7, the UE 120 may suspend or drop the uplink transmit switching operation (e.g., may refrain from switching the transmitting RF chain or antenna port from the CC2 to the CC1 as scheduled by a network entity). As shown by reference number 720, after the SRS carrier switching operation has completed, the UE 120 may autonomously configure or tune the transmitting RF chain or antenna port from the CC2 to the CC1, as indicated by the uplink transmit switching operation (e.g., without receiving a configuration or indication from a network entity causing the UE to switch the transmitting RF chain to the CC1). In other words, after the SRS carrier switching operation completes, the Tx chain may be re-tuned to CC2 (e.g., after being tuned to CC3 for the SRS carrier switching operation). The UE 120 may autonomously switch the Tx chain to CC1 (e.g., if there is sufficient switching time before next scheduled uplink transmission).

As shown by reference number 725, the UE 120 may receive scheduling to cause an uplink transmit switch to the CC2 after the UE 120 autonomously switches the Tx chain to CC1. For example, the UE 120 may receive a communication scheduling an uplink transmission associated with the second carrier (CC2) after tuning the transmitting RF chain to the first carrier (CC1). The UE 120 may switch the transmitting RF chain to the second carrier. The UE 120 may transmit the uplink transmission via the second carrier. As a result, there may be no unexpected interruption in the transmission of the uplink transmission because the UE 120 and/or the network entity scheduling the uplink transmission may know the expected RF chain status of the UE 120 after the suspension or dropping of the uplink transmit switching operation.

As indicated above, FIG. 7 is provided as an example. Other examples may differ from what is described with respect to FIG. 7.

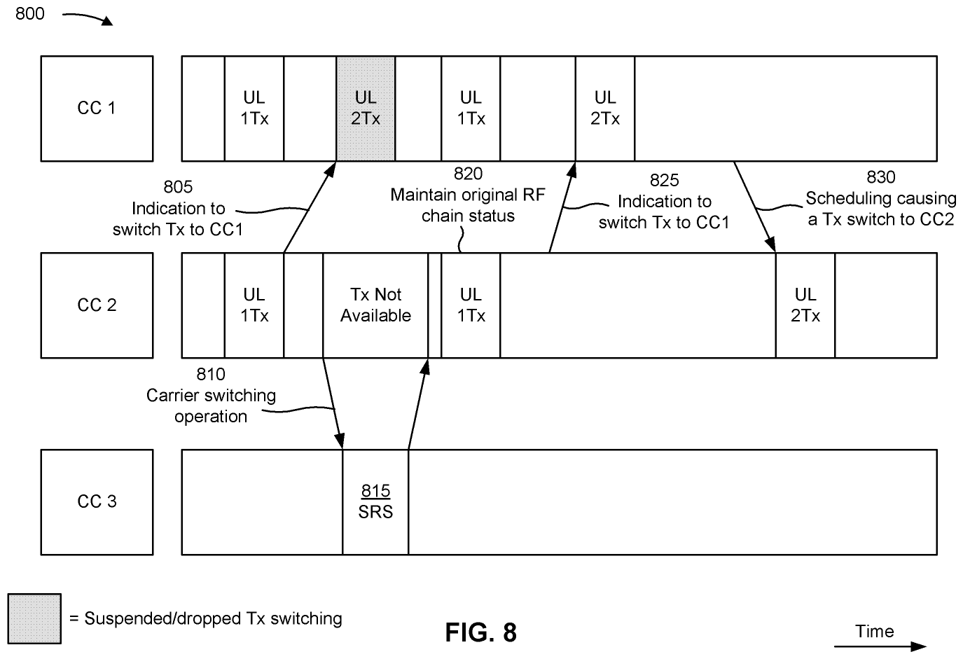

FIG. 8 is a diagram of an example 800 associated with resuming suspended transmit switching, in accordance with the present disclosure. The example 800 may be associated with an expected RF chain status of a UE 120 after a suspension of an uplink transmit switching operation (e.g., as described in more detail elsewhere herein) being the RF chain status of the UE 120 prior to receiving the indication to perform the uplink transmit switching operation. The UE 120 may be configured with 3 carriers or bands, such as the CC1, the CC2, and the CC3 (e.g., in a similar manner as described in connection with FIG. 6). The CC2 and the CC3 may be associated with an SRS carrier switching operation. The CC1 and the CC2 may be associated with an uplink transmit switching operation. In some aspects, the CC1 may be affected by the SRS carrier switching operation. In some aspects, the CC1 may be associated with (or scheduled by) a first network entity (e.g., the first network entity 605) and the CC2 and the CC3 may be associated with (or scheduled by) a second network entity (e.g., the second network entity 610).

For example, as shown in FIG. 8, an initial RF chain status of the UE 120 may include a first transmitting RF chain being tuned to the CC1 and a second transmitting RF chain being tuned to the CC2 (e.g., as shown by UL 1Tx on CC1 and UL 1Tx on CC2). As shown by reference number 805, the UE 120 may receive an indication to perform uplink transmit switching (e.g., to switch a transmitting RF chain or antenna port from the CC2 to the CC1). As shown by reference number 810, the UE 120 may perform an SRS carrier switching operation at a time that at least partially overlaps with the uplink transmit switching operation. For example, as shown by reference number 815, the UE 120 may transmit an SRS via the CC3 as part of the SRS carrier switching operation.

Because the CC2 and the CC1 may be affected by the SRS carrier switching operation (e.g., as described in more detail elsewhere herein), transmitting operations may be unavailable via the CC2 and the CC1 while the SRS carrier switching operation is ongoing. Therefore, as shown in FIG. 8, the UE 120 may suspend or drop the uplink transmit switching operation (e.g., may refrain from switching the transmitting RF chain or antenna port from the CC2 to the CC1 as scheduled by a network entity). As shown by reference number 820, after the SRS carrier switching operation has completed, the UE 120 may maintain the original RF chain status of the UE 120 (e.g., may ignore or not perform the RF chain status as indicated by the scheduling of the uplink transmit switching operation). For example, as shown in FIG. 8, after the SRS carrier switching operation is completed, the UE 120 may tune the transmitting RF chain from the CC3 back to the CC2, such that there is one transmitting RF chain tuned to the CC1 and one transmitting RF chain tuned to the CC2 (e.g., as was the case prior to the UE 120 performing the SRS carrier switching operation). For example, the UE 120 may configure the transmitting RF chain to be tuned to the second carrier (CC2). The UE 120 may refrain from configuring the transmitting RF chain as indicated by the indication to perform the uplink transmit switching operation.

At a later time, as shown by reference number 825, the UE 120 may receive (e.g., after configuring the transmitting RF chain to be tuned to the CC2) a communication scheduling an uplink transmission associated with the first carrier or the second carrier. The UE 120 may configure the transmitting RF chain to be tuned to a carrier, from the first carrier and the second carrier, as indicated by the communication. The UE 120 may transmit, using the first carrier or the second carrier, the second uplink transmission. For example, as depicted in FIG. 8, the communication may schedule an uplink communication on the CC1. Therefore, the UE 120 may switch or tune the transmitting RF chain from the CC2 to the CC1. By receiving additional scheduling on CC1, an RF status between the network entity that scheduled the original uplink transmit switching operation (e.g., that was dropped or suspended by the UE 120) and the UE 120 may again be aligned and/or synchronized (e.g., with two transmitting RF chains tuned to the CC1 as was indicated by the original uplink transmit switching operation).

As further shown in FIG. 8, and by reference number 830, the UE 120 may receive scheduling to cause an uplink transmit switch to the CC2 after the UE 120 switches the Tx chain to CC1 (e.g., caused by the additional scheduling communication received by the UE 120 as described in connection with reference number 825). For example, the UE 120 may receive a communication scheduling an uplink transmission associated with the second carrier (CC2) after tuning the transmitting RF chain to the first carrier (CC1). The UE 120 may switch the transmitting RF chain to the second carrier. The UE 120 may transmit the uplink transmission via the second carrier.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., the UE 120) performs operations associated with resuming suspended transmit switching.

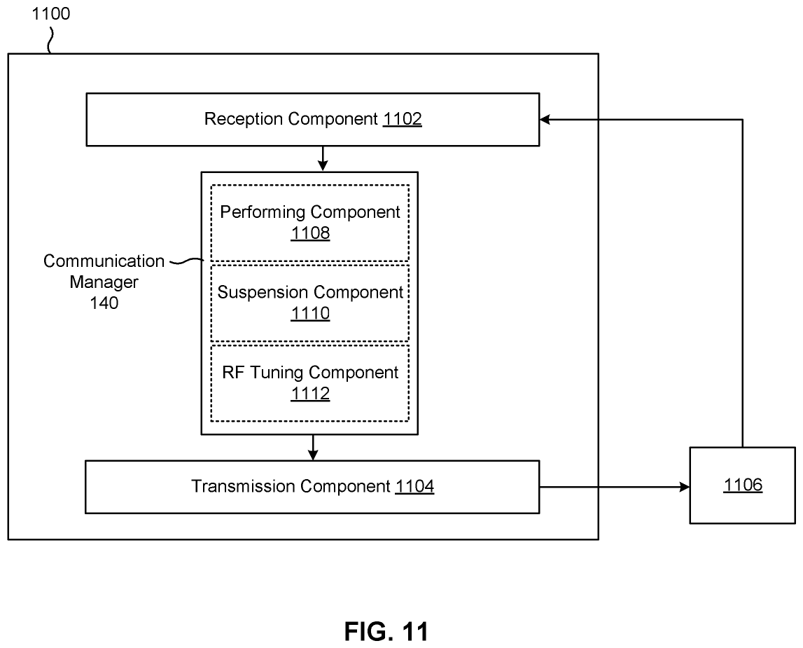

As shown in FIG. 9, in some aspects, process 900 may include transmitting, to a network entity, a first indication of one or more carriers, including a first carrier, that are affected by an operation associated with one or more other carriers (block 910). For example, the UE (e.g., using communication manager 140 and/or transmission component 1104, depicted in FIG. 11) may transmit, to a network entity, a first indication of one or more carriers, including a first carrier, that are affected by an operation associated with one or more other carriers, as described above.

As further shown in FIG. 9, in some aspects, process 900 may include receiving, from the network entity, a second indication to switch a transmitting RF chain of the UE from a second carrier to the first carrier at a first time for a first uplink transmission (block 920). For example, the UE (e.g., using communication manager 140 and/or reception component 1102, depicted in FIG. 11) may receive, from the network entity, a second indication to switch a transmitting RF chain of the UE from a second carrier to the first carrier at a first time for a first uplink transmission, as described above.

As further shown in FIG. 9, in some aspects, process 900 may include performing the operation associated with at least one of the second carrier or a third carrier at a second time that at least partially overlaps with the first time (block 930). For example, the UE (e.g., using communication manager 140 and/or performing component 1108, depicted in FIG. 11) may perform the operation associated with at least one of the second carrier or a third carrier at a second time that at least partially overlaps with the first time, as described above.

As further shown in FIG. 9, in some aspects, process 900 may include suspending the switch of the transmitting RF chain to the first carrier based at least in part on performing the operation (block 940). For example, the UE (e.g., using communication manager 140 and/or suspension component 1110, depicted in FIG. 11) may suspend the switch of the transmitting RF chain to the first carrier based at least in part on performing the operation, as described above.

As further shown in FIG. 9, in some aspects, process 900 may include configuring the transmitting RF chain to be tuned to the first carrier or the second carrier at a third time that occurs after the second time (block 950). For example, the UE (e.g., using communication manager 140 and/or RF tuning component 1112, depicted in FIG. 11) may configure the transmitting RF chain to be tuned to the first carrier or the second carrier at a third time that occurs after the second time, as described above.

Process 900 may include additional aspects, such as any single aspect or any combination of aspects described below and/or in connection with one or more other processes described elsewhere herein.

In a first aspect, process 900 includes transmitting, to the network entity and via the first carrier, the first uplink transmission or another uplink transmission based at least in part on configuring the transmitting RF chain to the first carrier.

In a second aspect, alone or in combination with the first aspect, process 900 includes transmitting a first capability indication associated with a first one or more carriers, including the first carrier and the second carrier, that are supported by the UE for uplink transmit switching, and transmitting an indication of a second one or more carriers associated with the operation, wherein the first one or more carriers and the second one or more carriers include at least one common carrier.

In a third aspect, alone or in combination with one or more of the first and second aspects, the operation includes an SRS carrier switching operation.

In a fourth aspect, alone or in combination with one or more of the first through third aspects, the operation ends at a fourth time, wherein a second uplink transmission is scheduled to occur at a fifth time that occurs after the fourth time, and wherein configuring the transmitting RF chain to be tuned to the first carrier is based at least in part on an amount of time between the fourth time and the fifth time satisfying a threshold.

In a fifth aspect, alone or in combination with one or more of the first through fourth aspects, configuring the transmitting RF chain includes configuring the transmitting RF chain to be tuned to the first carrier, and process 900 includes receiving, from the network entity, a communication scheduling a second uplink transmission associated with the second carrier, switching the transmitting RF chain to the second carrier, and transmitting the second uplink transmission via the second carrier.

In a sixth aspect, alone or in combination with one or more of the first through fifth aspects, configuring the transmitting RF chain includes configuring the transmitting RF chain to be tuned to the second carrier, and process 900 includes receiving, after configuring the transmitting RF chain, a communication scheduling a second uplink transmission associated with the first carrier or the second carrier, configuring the transmitting RF chain to be tuned to a carrier, from the first carrier and the second carrier, as indicated by the communication, and transmitting, using the first carrier or the second carrier, the second uplink transmission.

In a seventh aspect, alone or in combination with one or more of the first through sixth aspects, process 900 includes transmitting, to the network entity, an indication that the switch of the transmitting RF chain to the first carrier has been suspended.

In an eighth aspect, alone or in combination with one or more of the first through seventh aspects, configuring the transmitting RF chain includes configuring the transmitting RF chain to be tuned to the second carrier, and refraining from configuring the transmitting RF chain as indicated by the second indication.

In a ninth aspect, alone or in combination with one or more of the first through eighth aspects, the transmitting RF chain is associated with an antenna port.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., the first network entity 605, a base station 110, a CU, a DU, and/or an RU) performs operations associated with resuming suspended transmit switching.

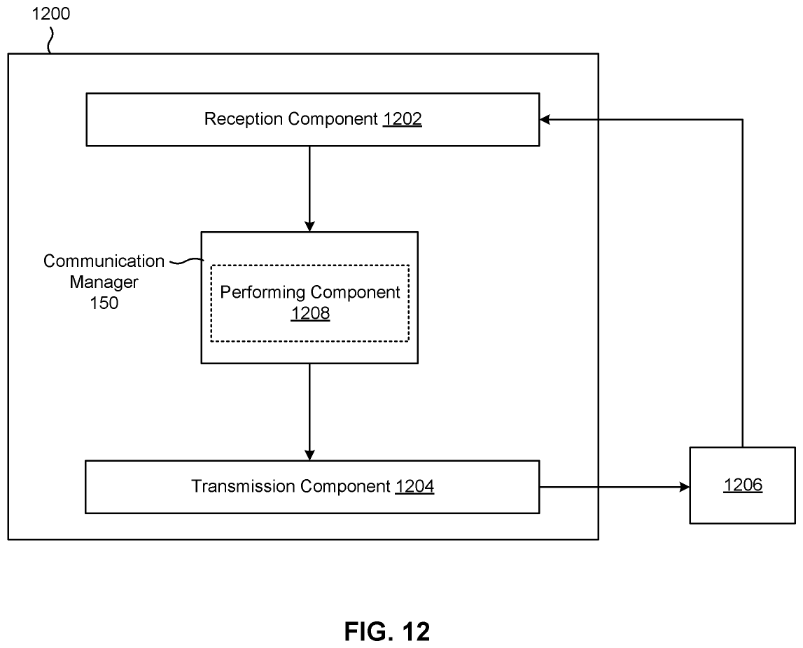

As shown in FIG. 10, in some aspects, process 1000 may include receiving a first indication of one or more carriers, including a first carrier, associated with a UE that are affected by an operation associated with one or more other carriers (block 1010). For example, the network entity (e.g., using communication manager 150 and/or reception component 1202, depicted in FIG. 12) may receive a first indication of one or more carriers, including a first carrier, associated with a UE that are affected by an operation associated with one or more other carriers, as described above.

As further shown in FIG. 10, in some aspects, process 1000 may include transmitting a second indication, intended for the UE, to switch a transmitting RF chain of the UE from a second carrier to the first carrier at a first time for a first uplink transmission (block 1020). For example, the network entity (e.g., using communication manager 15 and/or transmission component 1204, depicted in FIG. 12) may transmit a second indication, intended for the UE, to switch a transmitting RF chain of the UE from a second carrier to the first carrier at a first time for a first uplink transmission, as described above.

As further shown in FIG. 10, in some aspects, process 1000 may include performing one or more actions based at least in part on an expected RF configuration of the UE after a suspension of the switch of the transmitting RF chain to the first carrier based at least in part on a performance of the operation by the UE (block 1030). For example, the network entity (e.g., using communication manager 150 and/or performing component 1208, depicted in FIG. 12) may perform one or more actions based at least in part on an expected RF configuration of the UE after a suspension of the switch of the transmitting RF chain to the first carrier based at least in part on a performance of the operation by the UE, as described above.

Process 1000 may include additional aspects, such as any single aspect or any combination of aspects described below and/or in connection with one or more other processes described elsewhere herein.

In a first aspect, the expected RF configuration of the UE includes transmitting RF chain being tuned to the first carrier as indicated by the second indication.

In a second aspect, alone or in combination with the first aspect, process 1000 includes refraining from scheduling any uplink transmissions associated with the UE for a threshold amount of time after the performance of the operation by the UE has ended.

In a third aspect, alone or in combination with one or more of the first and second aspects, process 1000 includes transmitting, to the UE, a communication scheduling a second uplink transmission associated with the second carrier to cause the UE to switch the transmitting RF chain to the second carrier.

In a fourth aspect, alone or in combination with one or more of the first through third aspects, the expected RF configuration of the UE includes the transmitting RF chain being tuned to the second carrier.

In a fifth aspect, alone or in combination with one or more of the first through fourth aspects, process 1000 includes transmitting, to the UE, a communication scheduling a second uplink transmission associated with the first carrier to cause the UE to switch the transmitting RF chain to the first carrier.

In a sixth aspect, alone or in combination with one or more of the first through fifth aspects, process 1000 includes receiving, from the UE, a capability indication associated with a first one or more carriers, including the first carrier and the second carrier, that are supported by the UE for uplink transmit switching, and receiving, from the UE, an indication of a second one or more carriers associated with the operation, wherein the first one or more carriers and the second one or more carriers include at least one common carrier.

In a seventh aspect, alone or in combination with one or more of the first through sixth aspects, the operation includes an SRS carrier switching operation.

In an eighth aspect, alone or in combination with one or more of the first through seventh aspects, process 1000 includes receiving, from the UE, an indication that the switch of the transmitting RF chain to the first carrier has been suspended.

In a ninth aspect, alone or in combination with one or more of the first through eighth aspects, the expected RF configuration includes the UE dropping an RF configuration as indicated by the second indication.

In a tenth aspect, alone or in combination with one or more of the first through ninth aspects, the transmitting RF chain is associated with an antenna port.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a performing component 1108, a suspension component 1110, and/or an RF tuning component 1112, among other examples.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The transmission component 1104 may transmit, to a network entity, a first indication of one or more carriers, including a first carrier, that are affected by an operation associated with one or more other carriers. The reception component 1102 may receive, from the network entity, a second indication to switch a transmitting RF chain of the UE from a second carrier to the first carrier at a first time for a first uplink transmission. The performing component 1108 may perform the operation associated with at least one of the second carrier or a third carrier at a second time that at least partially overlaps with the first time. The suspension component 1110 may suspend the switch of the transmitting RF chain to the first carrier based at least in part on performing the operation. The RF tuning component 1112 may configure the transmitting RF chain to be tuned to the first carrier or the second carrier at a third time that occurs after the second time.

The transmission component 1104 may transmit, to the network entity and via the first carrier, the first uplink transmission or another uplink transmission based at least in part on configuring the transmitting RF chain to the first carrier.

The transmission component 1104 may transmit a first capability indication associated with a first one or more carriers, including the first carrier and the second carrier, that are supported by the UE for uplink transmit switching.

The transmission component 1104 may transmit an indication of a second one or more carriers associated with the operation, wherein the first one or more carriers and the second one or more carriers include at least one common carrier.

The transmission component 1104 may transmit, to the network entity, an indication that the switch of the transmitting RF chain to the first carrier has been suspended.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a performing component 1208, among other examples.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The reception component 1202 may receive a first indication of one or more carriers, including a first carrier, associated with a UE that are affected by an operation associated with one or more other carriers. The transmission component 1204 may transmit a second indication intended for the UE to switch a transmitting RF chain of the UE from a second carrier to the first carrier at a first time for a first uplink transmission. The performing component 1208 may perform one or more actions based at least in part on an expected RF configuration of the UE after a suspension of the switch of the transmitting RF chain to the first carrier based at least in part on a performance of the operation by the UE.

The performing component 1208 may refrain from scheduling any uplink transmissions associated with the UE for a threshold amount of time after the performance of the operation by the UE has ended.

The transmission component 1204 may transmit, to the UE, a communication scheduling a second uplink transmission associated with the second carrier to cause the UE to switch the transmitting RF chain to the second carrier.

The transmission component 1204 may transmit, to the UE, a communication scheduling a second uplink transmission associated with the first carrier to cause the UE to switch the transmitting RF chain to the first carrier.

The reception component 1202 may receive, from the UE, a capability indication associated with a first one or more carriers, including the first carrier and the second carrier, that are supported by the UE for uplink transmit switching.

The reception component 1202 may receive, from the UE, an indication of a second one or more carriers associated with the operation, wherein the first one or more carriers and the second one or more carriers include at least one common carrier.

The reception component 1202 may receive, from the UE, an indication that the switch of the transmitting RF chain to the first carrier has been suspended.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: transmitting, to a network entity, a first indication of one or more carriers, including a first carrier, that are affected by an operation associated with one or more other carriers; receiving, from the network entity, a second indication to switch a transmitting radio frequency (RF) chain of the UE from a second carrier to the first carrier at a first time for a first uplink transmission; performing the operation associated with at least one of the second carrier or a third carrier at a second time that at least partially overlaps with the first time; suspending the switch of the transmitting RF chain to the first carrier based at least in part on performing the operation; and configuring the transmitting RF chain to be tuned to the first carrier or the second carrier at a third time that occurs after the second time.
Aspect 2: The method of Aspect 1, further comprising: transmitting, to the network entity and via the first carrier, the first uplink transmission or another uplink transmission based at least in part on configuring the transmitting RF chain to the first carrier.
Aspect 3: The method of any of Aspects 1-2, further comprising: transmitting a first capability indication associated with a first one or more carriers, including the first carrier and the second carrier, that are supported by the UE for uplink transmit switching; and transmitting an indication of a second one or more carriers associated with the operation, wherein the first one or more carriers and the second one or more carriers include at least one common carrier.
Aspect 4: The method of any of Aspects 1-3, wherein the operation includes a sounding reference signal (SRS) carrier switching operation.
Aspect 5: The method of any of Aspects 1-4, wherein the operation ends at a fourth time, wherein a second uplink transmission is scheduled to occur at a fifth time that occurs after the fourth time, and wherein configuring the transmitting RF chain to be tuned to the first carrier is based at least in part on an amount of time between the fourth time and the fifth time satisfying a threshold.
Aspect 6: The method of any of Aspects 1-5, wherein configuring the transmitting RF chain comprises configuring the transmitting RF chain to be tuned to the first carrier, the method further comprising: receiving, from the network entity, a communication scheduling a second uplink transmission associated with the second carrier; switching the transmitting RF chain to the second carrier; and transmitting the second uplink transmission via the second carrier.
Aspect 7: The method of any of Aspects 1-5, wherein configuring the transmitting RF chain comprises configuring the transmitting RF chain to be tuned to the second carrier, the method further comprising: receiving, after configuring the transmitting RF chain, a communication scheduling a second uplink transmission associated with the first carrier or the second carrier; configuring the transmitting RF chain to be tuned to a carrier, from the first carrier and the second carrier, as indicated by the communication; and transmitting, using the first carrier or the second carrier, the second uplink transmission.
Aspect 8: The method of any of Aspects 1-7, further comprising: transmitting, to the network entity, an indication that the switch of the transmitting RF chain to the first carrier has been suspended.
Aspect 9: The method of any of Aspects 1-8, wherein configuring the transmitting RF chain comprises: configuring the transmitting RF chain to be tuned to the second carrier; and refraining from configuring the transmitting RF chain as indicated by the second indication.
Aspect 10: The method of any of Aspects 1-9, wherein the transmitting RF chain is associated with an antenna port.
Aspect 11: A method of wireless communication performed by a network entity, comprising: receiving a first indication of one or more carriers, including a first carrier, associated with a user equipment (UE), that are affected by an operation associated with one or more other carriers; transmitting a second indication, intended for the UE, to switch a transmitting radio frequency (RF) chain of the UE from a second carrier to the first carrier at a first time for a first uplink transmission; and performing one or more actions based at least in part on an expected RF configuration of the UE after a suspension of the switch of the transmitting RF chain to the first carrier based at least in part on a performance of the operation by the UE.
Aspect 12: The method of Aspect 11, wherein the expected RF configuration of the UE includes transmitting RF chain being tuned to the first carrier as indicated by the second indication.
Aspect 13: The method of Aspect 12, further comprising: refraining from scheduling any uplink transmissions associated with the UE for a threshold amount of time after the performance of the operation by the UE has ended.
Aspect 14: The method of any of Aspects 12-13, further comprising: transmitting, to the UE, a communication scheduling a second uplink transmission associated with the second carrier to cause the UE to switch the transmitting RF chain to the second carrier.
Aspect 15: The method of Aspect 11, wherein the expected RF configuration of the UE includes the transmitting RF chain being tuned to the second carrier.
Aspect 16: The method of Aspect 15, further comprising: transmitting, to the UE, a communication scheduling a second uplink transmission associated with the first carrier to cause the UE to switch the transmitting RF chain to the first carrier.
Aspect 17: The method of any of Aspects 11-16, further comprising: receiving, from the UE, a capability indication associated with a first one or more carriers, including the first carrier and the second carrier, that are supported by the UE for uplink transmit switching; and receiving, from the UE, an indication of a second one or more carriers associated with the operation, wherein the first one or more carriers and the second one or more carriers include at least one common carrier.
Aspect 18: The method of any of Aspects 11-17, wherein the operation includes a sounding reference signal (SRS) carrier switching operation.
Aspect 19: The method of any of Aspects 11-18, further comprising: receiving, from the UE, an indication that the switch of the transmitting RF chain to the first carrier has been suspended.
Aspect 20: The method of any of Aspects 11-19, wherein the expected RF configuration includes the UE dropping an RF configuration as indicated by the second indication.
Aspect 21: The method of any of Aspects 11-20, wherein the transmitting RF chain is associated with an antenna port.
Aspect 22: An apparatus for wireless communication at a device, comprising a processor; memory coupled with the processor; and instructions stored in the memory and executable by the processor to cause the apparatus to perform the method of one or more of Aspects 1-10.
Aspect 23: A device for wireless communication, comprising a memory and one or more processors coupled to the memory, the one or more processors configured to perform the method of one or more of Aspects 1-10.
Aspect 24: An apparatus for wireless communication, comprising at least one means for performing the method of one or more of Aspects 1-10.
Aspect 25: A non-transitory computer-readable medium storing code for wireless communication, the code comprising instructions executable by a processor to perform the method of one or more of Aspects 1-10.
Aspect 26: A non-transitory computer-readable medium storing a set of instructions for wireless communication, the set of instructions comprising one or more instructions that, when executed by one or more processors of a device, cause the device to perform the method of one or more of Aspects 1-10.
Aspect 27: An apparatus for wireless communication at a device, comprising a processor; memory coupled with the processor; and instructions stored in the memory and executable by the processor to cause the apparatus to perform the method of one or more of Aspects 11-21.
Aspect 28: A device for wireless communication, comprising a memory and one or more processors coupled to the memory, the one or more processors configured to perform the method of one or more of Aspects 11-21.
Aspect 29: An apparatus for wireless communication, comprising at least one means for performing the method of one or more of Aspects 11-21.
Aspect 30: A non-transitory computer-readable medium storing code for wireless communication, the code comprising instructions executable by a processor to perform the method of one or more of Aspects 11-21.
Aspect 31: A non-transitory computer-readable medium storing a set of instructions for wireless communication, the set of instructions comprising one or more instructions that, when executed by one or more processors of a device, cause the device to perform the method of one or more of Aspects 11-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
transmitting, to a network entity, a first indication of one or more carriers, including a first carrier, that are affected by an operation associated with one or more other carriers;
receiving, from the network entity, a second indication to switch a transmitting radio frequency (RF) chain of the UE from a second carrier to the first carrier at a first time for a first uplink transmission;
performing the operation associated with at least one of the second carrier or a third carrier at a second time that at least partially overlaps with the first time;
suspending the switch of the transmitting RF chain to the first carrier based at least in part on performing the operation; and
configuring the transmitting RF chain to be tuned to the first carrier or the second carrier at a third time that occurs after the second time.

2. The method of claim 1, further comprising:
transmitting, to the network entity and via the first carrier, the first uplink transmission or another uplink transmission based at least in part on configuring the transmitting RF chain to the first carrier.

3. The method of claim 1, further comprising:
transmitting a first capability indication associated with a first one or more carriers, including the first carrier and the second carrier, that are supported by the UE for uplink transmit switching; and
transmitting an indication of a second one or more carriers associated with the operation, wherein the first one or more carriers and the second one or more carriers include at least one common carrier.

4. The method of claim 1, wherein the operation includes a sounding reference signal (SRS) carrier switching operation.

5. The method of claim 1, wherein the operation ends at a fourth time, wherein a second uplink transmission is scheduled to occur at a fifth time that occurs after the fourth time, and
wherein configuring the transmitting RF chain to be tuned to the first carrier is based at least in part on an amount of time between the fourth time and the fifth time satisfying a threshold.

6. The method of claim 1, wherein configuring the transmitting RF chain comprises configuring the transmitting RF chain to be tuned to the first carrier, the method further comprising:
receiving, from the network entity, a communication scheduling a second uplink transmission associated with the second carrier;
switching the transmitting RF chain to the second carrier; and
transmitting the second uplink transmission via the second carrier.

7. The method of claim 1, wherein configuring the transmitting RF chain comprises configuring the transmitting RF chain to be tuned to the second carrier, the method further comprising:
receiving, after configuring the transmitting RF chain, a communication scheduling a second uplink transmission associated with the first carrier or the second carrier;
configuring the transmitting RF chain to be tuned to a carrier, from the first carrier and the second carrier, as indicated by the communication; and
transmitting, using the first carrier or the second carrier, the second uplink transmission.

8. The method of claim 1, wherein configuring the transmitting RF chain comprises:
configuring the transmitting RF chain to be tuned to the second carrier; and
refraining from configuring the transmitting RF chain as indicated by the second indication.

9. A method of wireless communication performed by a network entity, comprising:
receiving a first indication of one or more carriers, including a first carrier, associated with a user equipment (UE) that are affected by an operation associated with one or more other carriers;
transmitting a second indication intended for the UE to switch a transmitting radio frequency (RF) chain of the UE from a second carrier to the first carrier at a first time for a first uplink transmission; and
performing one or more actions based at least in part on an expected RF configuration of the UE after a suspension of the switch of the transmitting RF chain to the first carrier based at least in part on a performance of the operation by the UE.

10. The method of claim 9, wherein the expected RF configuration of the UE includes transmitting RF chain being tuned to the first carrier as indicated by the second indication.

11. The method of claim 10, further comprising:
refraining from scheduling any uplink transmissions associated with the UE for a threshold amount of time after the performance of the operation by the UE has ended.

12. The method of claim 9, wherein the expected RF configuration of the UE includes the transmitting RF chain being tuned to the second carrier.

13. The method of claim 9, further comprising:
receiving, from the UE, a capability indication associated with a first one or more carriers, including the first carrier and the second carrier, that are supported by the UE for uplink transmit switching; and
receiving, from the UE, an indication of a second one or more carriers associated with the operation, wherein the first one or more carriers and the second one or more carriers include at least one common carrier.

14. The method of claim 9, wherein the operation includes a sounding reference signal (SRS) carrier switching operation.

15. The method of claim 9, wherein the expected RF configuration includes the UE dropping an RF configuration as indicated by the second indication.

16. A user equipment (UE) for wireless communication, comprising:
a memory; and
one or more processors, coupled to the memory, configured to:
transmit, to a network entity, a first indication of one or more carriers, including a first carrier, that are affected by an operation associated with one or more other carriers;
receive, from the network entity, a second indication to switch a transmitting radio frequency (RF) chain of the UE from a second carrier to the first carrier at a first time for a first uplink transmission;
perform the operation associated with at least one of the second carrier or a third carrier at a second time that at least partially overlaps with the first time;
suspend the switch of the transmitting RF chain to the first carrier based at least in part on performing the operation; and
configure the transmitting RF chain to be tuned to the first carrier or the second carrier at a third time that occurs after the second time.

17. The UE of claim 16, wherein the one or more processors are further configured to:
transmit, to the network entity and via the first carrier, the first uplink transmission or another uplink transmission based at least in part on configuring the transmitting RF chain to the first carrier.

18. The UE of claim 16, wherein the one or more processors are further configured to:
transmit a first capability indication associated with a first one or more carriers, including the first carrier and the second carrier, that are supported by the UE for uplink transmit switching; and
transmit an indication of a second one or more carriers associated with the operation, wherein the first one or more carriers and the second one or more carriers include at least one common carrier.

19. The UE of claim 16, wherein the operation includes a sounding reference signal (SRS) carrier switching operation.

20. The UE of claim 16, wherein the operation ends at a fourth time, wherein a second uplink transmission is scheduled to occur at a fifth time that occurs after the fourth time, and
wherein configuring the transmitting RF chain to be tuned to the first carrier is based at least in part on an amount of time between the fourth time and the fifth time satisfying a threshold.

21. The UE of claim 16, wherein the one or more processors, to configure the transmitting RF chain, are configured to configure the transmitting RF chain to be tuned to the second carrier, and wherein the one or more processors are further configured to:
receive, after configuring the transmitting RF chain, a communication scheduling a second uplink transmission associated with the first carrier or the second carrier;
configure the transmitting RF chain to be tuned to a carrier, from the first carrier and the second carrier, as indicated by the communication; and
transmit, using the first carrier or the second carrier, the second uplink transmission.

22. The UE of claim 16, wherein the one or more processors, to configure the transmitting RF chain, are configured to:
configure the transmitting RF chain to be tuned to the second carrier; and
refrain from configuring the transmitting RF chain as indicated by the second indication.

23. A network entity for wireless communication, comprising:
a memory; and
one or more processors, coupled to the memory, configured to:
receive a first indication of one or more carriers, including a first carrier, associated with a user equipment (UE) that are affected by an operation associated with one or more other carriers;
transmit a second indication intended for the UE to switch a transmitting radio frequency (RF) chain of the UE from a second carrier to the first carrier at a first time for a first uplink transmission; and
perform one or more actions based at least in part on an expected RF configuration of the UE after a suspension of the switch of the transmitting RF chain to the first carrier based at least in part on a performance of the operation by the UE.

24. The network entity of claim 23, wherein the expected RF configuration of the UE includes transmitting RF chain being tuned to the first carrier as indicated by the second indication.

25. The network entity of claim 24, wherein the one or more processors are further configured to:
refrain from scheduling any uplink transmissions associated with the UE for a threshold amount of time after the performance of the operation by the UE has ended.

26. The network entity of claim 23, wherein the expected RF configuration of the UE includes the transmitting RF chain being tuned to the second carrier.

27. The network entity of claim 26, wherein the one or more processors are further configured to:
transmit, to the UE, a communication scheduling a second uplink transmission associated with the first carrier to cause the UE to switch the transmitting RF chain to the first carrier.

28. The network entity of claim 23, wherein the one or more processors are further configured to:
receive, from the UE, a capability indication associated with a first one or more carriers, including the first carrier and the second carrier, that are supported by the UE for uplink transmit switching; and
receive, from the UE, an indication of a second one or more carriers associated with the operation, wherein the first one or more carriers and the second one or more carriers include at least one common carrier.

29. The network entity of claim 23, wherein the expected RF configuration includes the UE dropping an RF configuration as indicated by the second indication.

30. The network entity of claim 23, wherein the transmitting RF chain is associated with an antenna port.
